(19) United States
(12) Patent Application Publication
(10) Pub. No.: US 2014/0290784 A1
(43) Pub. Date: Oct. 2, 2014

(54) REINFORCEMENT LAMINATE HAVING AN ALIGNMENT FEATURE

(71) Applicant: David Michael McCall, Rosenberg, TX (US)

(72) Inventor: David Michael McCall, Rosenberg, TX (US)

(73) Assignee: DeepFlex Inc., Houston, TX (US)

(21) Appl. No.: 14/114,532

(22) PCT Filed: May 9, 2012
(86) PCT No.: PCT/US2012/037002

§ 371 Date: Oct. 29, 2013

Related U.S. Application Data
(60) Provisional application No. 61/485,941, filed on May 13, 2011.

(51) Int. Cl. F16L 9/14; B32B 3/30; B32B 7/04; B32B 3/28

(52) U.S. Cl. CPC F16L 9/14; B32B 3/28; B32B 3/30; B32B 7/04
USPC 138/151; 29/407.1; 428/174; 428/161

(57) ABSTRACT

In one aspect, the present disclosure relates to a reinforcement stack of a spoolable pipe composed of a plurality of laminates stacked to form the reinforcement stack. At least one of the plurality of laminates includes an alignment feature configured to align adjacently stacked laminates. In another aspect, the present disclosure relates to a method to manufacture a reinforcement stack of a spoolable pipe. The method includes providing an alignment feature on at least one laminate of a plurality of laminates and arranging the plurality of laminates using the alignment feature to form the reinforcement stack. In another aspect, the present disclosure relates to an armor layer of an unbonded flexible pipe. The armor layer includes a plurality of laminates stacked to form a reinforcement stack of the armor layer in which each laminate of the plurality of laminates comprises an alignment feature to align adjacent laminates.

### BACKGROUND OF INVENTION

1. Field of the Disclosure

The present disclosure relates to an alignment feature of reinforcement laminate used in armor layers of spoolable pipe.

2. Description of the Related Art

Spoolable pipe, such as flexible fiber-reinforced pipe is used in natural resource deposit extraction. For example, one type of spoolable pipe is unbonded flexible fiber-reinforced pipes that may be made with reinforcement stacks composed of fiber-reinforced polymer composite tape or laminate and applied to form armor layers for the flexible pipe. Inter-laminar adhesive may be applied to surfaces of the tapes to allow for bonding between the tapes to form a reinforcement stack of the armor layer. After application of the adhesive, the reinforcement stack may be helically wrapped on a pipe and cured, thereby allowing the inter-laminar adhesive to bond and strengthen the reinforcement stack. The laminate of the reinforcement stack may be a unidirectional fibrous tape, or combinations of tapes and/or other elements, providing high longitudinal strength to the stack, and, therefore, to the armor layer.

Examples of unidirectional tape stacks are described in U.S. Pat. No. 6,491,779 issued to Michael J. Bryant, on Dec. 10, 2002 and entitled “Method of Forming a Composite Tubular Assembly,” U.S. Pat. No. 6,804,942 issued to Michael J. Bryant, on Oct. 19, 2004 and entitled “Composite Tubular Assembly and Method of Forming Same,” and U.S. Pat. No. 7,073,978 issued to Michael J. Bryant, on Jul. 11, 2006 and entitled “Lightweight Catenary System,” each incorporated by reference in its entirety herein.

### SUMMARY OF INVENTION

In one aspect, the present disclosure relates to a reinforcement stack of a spoolable pipe composed of a plurality of laminates stacked to form the reinforcement stack. At least one of the plurality of laminates includes a alignment feature configured to align adjacently stacked laminates.

In another aspect, the present disclosure relates to a method to manufacture a reinforcement stack of a spoolable pipe. The method includes providing an alignment feature on at least one laminate of a plurality of laminates and arranging the plurality of laminates using the alignment feature to form the reinforcement stack.

In another aspect, the present disclosure relates to a reinforcement stack of a spoolable pipe. The reinforcement stack includes a plurality of stacked laminates in which at least one of the plurality of laminates comprises an alignment means for arranging the plurality of laminates about a centerline of the reinforcement stack.

In another aspect, the present disclosure relates to a spoolable pipe. The spoolable pipe includes a liner, one or more armor layers disposed external to the liner, and an outer jacket disposed external to the one or more armor layers. The at least one of the one or more armor layers includes a plurality of laminates stacked to form a reinforcement stack of the armor layer in which at least one of the plurality of laminates comprises a alignment feature configured to align adjacent laminates.

In another aspect, the present disclosure relates to an armor layer of a spoolable pipe. The armor layer includes a plurality of laminates stacked to form a reinforcement stack of the armor layer in which each laminate of the plurality of laminates comprises an alignment feature to align adjacent laminates.

### BRIEF DESCRIPTION OF DRAWINGS

FIG. 1A is an isometric view of a spoolable pipe in accordance with one or more embodiments of the present disclosure; FIG. 1B is a cross-sectional view of a spoolable pipe in accordance with one or more embodiments of the present disclosure;

FIG. 2 shows a cross-sectional view of reinforcement stacks of a spoolable pipe;

FIG. 3 shows a cross-sectional view of a laminate and a reinforcement stack in accordance with one or more embodiments of the present disclosure;

FIG. 4 shows a cross-sectional view of a laminate and a reinforcement stack in accordance with one or more embodiments of the present disclosure;

FIG. 5 shows a cross-sectional view of a laminate and a reinforcement stack in accordance with one or more embodiments of the present disclosure.

FIG. 6 shows a cross-sectional view of a laminates in accordance with one or more embodiments of the present disclosure

### DETAILED DESCRIPTION

It should be understood that the following disclosure provides examples for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In view of the above, tapes or laminates of reinforcement stacks of an armor layer of a spoolable pipe with one or more alignment features are provided herein. Spoolable pipe, for example, flexible pipe, such as unbonded Flexible Fiber Reinforced Pipe (FFRP®) as developed by DeepFlex, Inc., may be constructed from extruded polymer fluid barrier layers and metallic or composite armor layers. The unique design of bonding multiple thin reinforcement tapes or laminates to form reinforcement stacks with interlaminar adhesive allows the reinforcement material to provide resistance to internal and external pressure and axial tension and compression loads experienced by the spoolable pipe. The higher axial compression capacity of the flexible pipe structure laminated reinforcement stack may overcome challenges faced in previous composite armored flexible pipe designs which employ multiple thin fiber reinforced polymer tapes. Although discussed herein with respect to a flexible pipe of the structure described, those skilled in the art will appreciate that embodiments are not limited thereto, and embodiments disclosed herein may be applied to any spoolable pipe known in the art including pipes with an internal carcass.

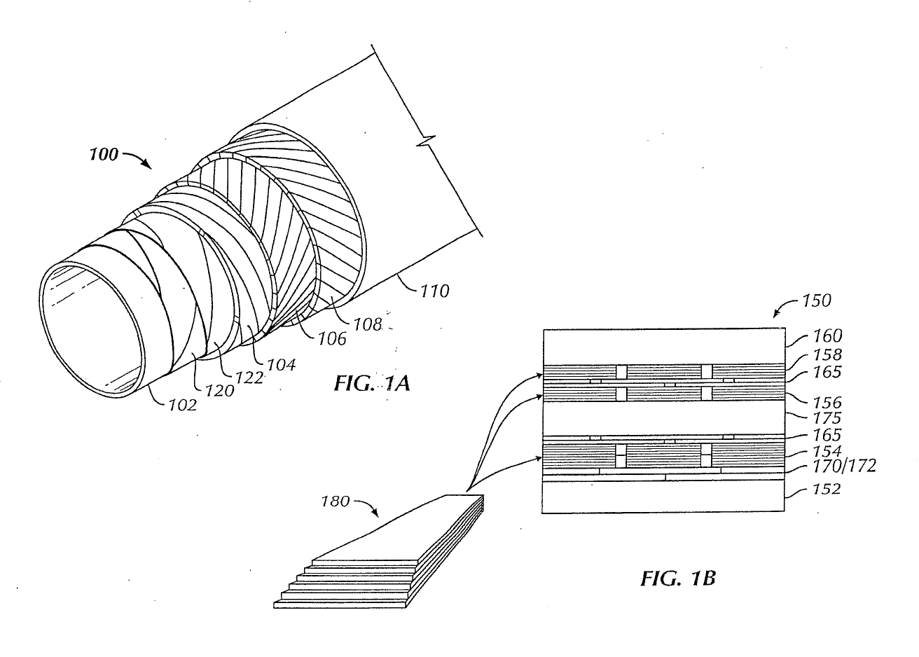

Referring initially to FIG. 1A, an isometric view of a spoolable pipe 100 is shown. A liner 102 may be wrapped with one or more armor layers and additional structural and/or functional layers. For example, armor layer 106, composed of reinforcement stacks comprising stacks of laminates helically wrapped in a first orientation, and armor layer 108, composed of reinforcement stacks comprising stacks of laminates helically wrapped in a second orientation, may be provided as structural layers of pipe 100. Further, one or more armor layers 104, composed of helically wrapped reinforcement stacks comprising stacks of laminates, may be wrapped at different, for example higher, lay-angles to form additional armor layers with different functional characteristics. Anti-wear layers (not shown) may be disposed between armor layers 104, 106, and 108 and one or more anti-extrusion layers 120 and 122 may be disposed between innermost armor layer 104 and liner 102. A jacket 110 may cover the armor layers and other elements of the pipe 100 to provide external protection.

Referring now to FIG. 1B, a cross-sectional view of a spoolable pipe 150 is shown. A liner 152 may be wrapped with one or more armor layers and additional structural and/or functional layers. For example, armor layers 154, 156, and 158 may be provided as structural layers of pipe 150. Armor layers 154, 156, and 158 may be composed of stacks of laminates and/or tape 180. Anti-wear layers 165 may be disposed between armor layers 156 and 158 and/or between armor layer 154 and a membrane 175. Further, one or more anti-extrusion layers 170 and 172 may be disposed between inner most armor layer 154 and liner 152. A jacket 160 may cover the armor layers and other elements of the pipe 150 to provide external protection.

Although FIGS. 1A and 1B depict pipe structures 100 and 150 of a spoolable pipe, these are merely for example only, and those skilled in the art will appreciate that a spoolable pipe may include additional and/or different layers, without departing from the scope of the present disclosure. For example, a spoolable pipe structure may include various combinations of liners, carcasses, hoop-strength or pressure armor layers, anti-wear layers, lubricating layers, tensile minor layers, anti-extrusion layers, membranes, and/or any other layers as may be included in a spoolable and/or flexible pipe, without departing from the scope of the present disclosure.

Referring again to FIG. 1A, armor layers 104, 106, 108 may provide various structural protection and/or strength to spoolable pipe 100. For example, the reinforcement stacks of armor layer 104 may be configured and oriented to form a hoop-strength armor layer and the reinforcement stacks of armor layers 106 and 108 may be configured and oriented to form tensile armor layers. Generally, as used herein, an armor layer may be a tensile armor layer, a hoop-strength armor layer, or other reinforcement and/or structural armor layer of a spoolable or flexible pipe and may be composed of one or more stacks of laminates and/or reinforcement tape, as discussed hereinafter.

The reinforcement stacks of minor layers 104, 106, and 108 may be composed of stacks of laminates. The laminates may be made of one or more stacked fiber-reinforced tapes (reinforcement tapes) that may be laminated and bonded together with an interlaminate layer or tape or may be a single structural member. The reinforcement tapes of the laminates may be unidirectional tape and/or other structural and/or reinforced tape. The reinforcement tape may include unidirectional, longitudinally, oriented fibers, providing strength in the longitudinal direction of the tape. The individual reinforcement tapes may be composed of the unidirectional fibers laminated, or bonded, by a material, such as a matrix material, that may provide strength in the width direction of the stack, thereby increasing the compressive capacity of the reinforcement tape.

The laminates or reinforcement tapes may be formed from fibers encapsulated in polymers, and bonding between adjacent laminates in a reinforcement stack may require heat, radiation, or normal force to bond the laminates to adjacently stacked laminates to achieve appropriate operational properties. For example, the reinforcement stacks may be chemically resistant, thermally insulated, strong enough to provide support, flexible enough to provide relative movement and/or sliding, flexible enough to allow the pipe to bend, and/or configured to any other necessary and/or required operational properties.

As noted, the laminates may be fiber-reinforced tapes. The laminates may be composed of composite matrix materials and/or polymers, including, but not limited to polyphenylene sulfide, polyetheretherketone, polyvinylidene halide, vinyl halide polymer, vinyl halide copolymer, polyvinyl ketone, polyvinyl ether, vinyl ester, hybrid epoxy vinyl ester, polyvinyl methyl ether, polyvinyl aromatic, silicone, acrylic polymer, acrylic copolymer, polybutylmethacrylate, polyacrylonitrile, acrylonitrile-styrene copolymer, ethylene-methyl methacrylate copolymer, polyamide, polyimide, polyether, polyhedral oligomeric silsesquioxane epoxy hybrid, epoxy resin, polyurethane, and/or polyoxymethylene and/or combinations thereof. The composite matrix materials and/or polymers that compose the fiber reinforced tapes may be partially or fully cured or hardened. As formed from the fiber reinforced tapes, the fibers of the laminate may be unidirectional in orientation, allowing for maximum longitudinal strength when a reinforcement stack is formed. Laminates with unidirectional fibers may be formed using a pultrusion process. Additionally, the fibers of the fiber reinforced tapes may be made of materials such as aramids, aromatics, ceramics, polyolefin, carbon fiber, graphite fiber, fiberglass, E-glass, chemical resistant E-glass, S-glass, metallic fibers, and/or any other fibrous material and/or any combinations thereof.

The laminates may be gathered, collected, and/or consolidated to form a reinforcement stack at the time of installation of the reinforcement stacks onto the surface of the pipe when forming an armor layer, or the laminates may be formed in segments and stored for later application onto a pipe structure. Further, application of a bonding material to bond adjacent laminates in a reinforcement stack, such as an inter-laminar adhesive, may be applied during the reinforcement stack forming and installation processes or during formation of a laminate. The bonding material may be any suitable thermoset or thermoplastic material that provides sufficient bonding strength to keep the laminates from delaminating in service.

As used herein a laminate is a tape structure or element of a reinforcement stack. In particular a laminate may be a single reinforcement tape or may be a reinforcement tape with additional properties or elements within and/or attached thereto. For example, a laminate may be a modified reinforcement tape that includes cross-woven fibers, or weft fibers, that may be configured with the longitudinal fibers of the reinforcement tape prior to lamination of the fibers to form the tape. Alternatively, a laminate may be two tapes bonded together. For example, a laminate may be a reinforcement tape bonded with a fibrous tape in which the fibers of the fibrous tape may be configured at one or more different angles from the direction of the longitudinal fibers of the reinforcement tape. Alternatively still, a fabric tape may be bonded to a reinforcement tape to form a laminate. Moreover, laminates may be formed in any manner and incorporate any known elements without departing from the scope of the present disclosure. In accordance with one or more embodiments of the present disclosure, the fibers that are cross-woven, in the fibrous or fabric tape, may be substantially perpendicular to the fibers of the reinforcement tape. Although described herein as perpendicular, those skilled in the art will appreciate that the fibers of the cross-weave, fibrous tape, or fabric tape may be any angle or assortment of angles with respect to the fibers of the reinforcement tape, without departing from the scope of the present disclosure. Examples of a fibrous tape may be found in WIPO Patent Application No. PCT/US2011/032988, entitled “Spoolable Pipe with Increased Compressive Strength and Method of Manufacture” to Mark Kalman et al., filed on Apr. 19, 2011, and incorporated by reference in its entirety herein.

As noted, at the time of application to the pipe, the reinforcement stacks may be partially bonded. The tape layers that may form the laminates of the reinforcement stacks may be partially cured or hardened or fully cured or hardened at the time of applying the reinforcement stacks to the pipe. An inter-laminar adhesive may provide bonding between adjacent laminates stacked in the reinforcement stack, and may also provide additional strength to the reinforcement stack. As disclosed herein, one or more embodiments of the present disclosure may provide an increased compressive strength through application of an inter-laminar adhesive and a fiber tape with fibers oriented, at least, substantially perpendicular to the fibers of the reinforcement tape. According to one or more embodiments of the present disclosure, the reinforcement stacks may be formed by placing a fabric tape between each layer of reinforcement tape that may be collected (or stacked) to form the reinforcement stack. Alternatively, the fabric tape may be combined with a reinforcement tape to form a laminate of the reinforcement stack.

During formation of the reinforcement stacks that comprise the armor layers of a spoolable pipe, the reinforcement stacks may be aligned so that unnecessary gaps and/or improper stack formation may be avoided. Although rails, guide members, and/or other mechanical alignment tools may be used, the laminates of the reinforcement stacks may slide and/or shift relative to adjacently stacked laminates in a reinforcement stack during the winding/wrapping process or after application to an underlying pipe layer surface. Accordingly, in accordance with one or more embodiments of the present disclosure, one or more laminates of the reinforcement stack may be provided with an alignment feature configured to augment formation of substantially rectangular reinforcement stacks, preventing the individual laminates from sliding and/or shifting relative to adjacent laminates within the reinforcement stack or relative to an adjacent reinforcement stack of the armor layer.

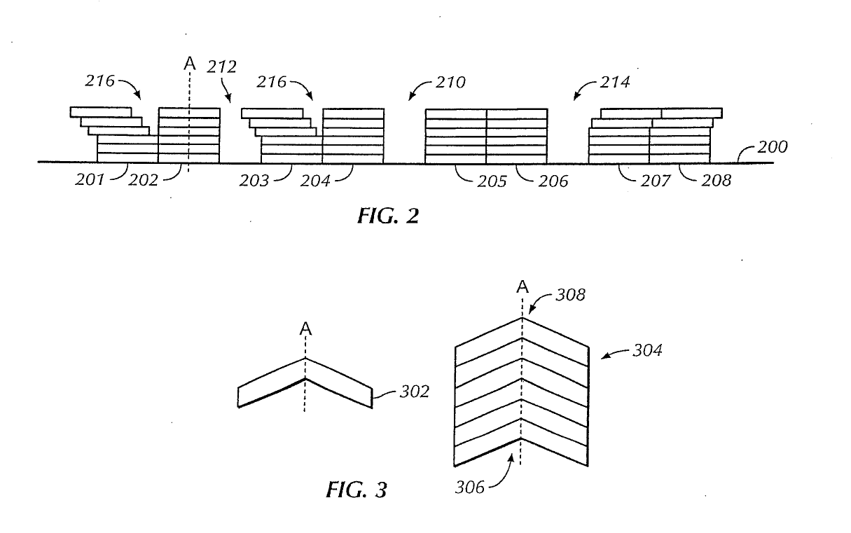

Referring now to FIG. 2, reinforcement stacks without an alignment feature are shown as applied to a surface 200 of a spoolable pipe. Surface 200 may be a previously wrapped layer, such as an armor layer, an anti-wear layer, an anti-extrusion layer, or any other layer or surface of a spoolable pipe.

Reinforcement stacks 201-208 are shown in FIG. 2. FIG. 2 represents a cross-sectional view of reinforcement stacks 201-208 as applied to a surface 200 of a pipe when forming an armor layer. Spacing, or gaps, may be provided between adjacent windings or wrappings of the reinforcement stacks 201-208. For example, a gap 210 may be intentionally formed to allow the reinforcement stacks to move relative to each other. The gap 210 may be provided to allow for bending of the pipe without adjacent reinforcement stacks substantially interfering at the inside radius of the pipe bend while bending the pipe in installation or operation. The allowed relative movement may allow for flexibility in the pipe structure and to reduce wear between adjacently wrapped windings of reinforcement stacks.

As shown in FIG. 2, reinforcement stacks 202, 204, 205, and 206 are stacks of aligned laminates forming a generally or substantially rectangular shape. The generally rectangular shape is characterized by all of the laminates of a stack being symmetrical about a center-line A of the reinforcement stack, as shown with respect to reinforcement stack 202. Ideally, the center-line A is a radial line from the pipe axis. As shown, gap 210 is an ideal or intended gap between two adjacently wrapped rectangular reinforcement stacks 204 and 205. However, reinforcement stacks 201, 203, 207, and 208 are shown with an offset of the center line of the laminates of the reinforcement stacks from the center-line A, thereby deviating from the generally rectangular shape and thereby preventing formation of the intended gap formation.

Due to the offset of the laminates of reinforcement stacks 201, 203, 207, and 208, the gaps between adjacently wrapped reinforcement stacks may be altered. For example, gap 212, between reinforcement stack 202 and reinforcement stack 203, may be smaller than the ideal gap 210, at least at one portion of the gap. As shown, gap 212 is smaller than the ideal spacing 210 at the top of reinforcement stacks 202 and 203. Further, gap 214, between reinforcement stack 206 and reinforcement stack 207, may be larger than the ideal gap 210, again shown at the top of the reinforcement stacks 206 and 207.

Additionally, unintended gaps, such as gap 216, may form between two stacks that are wrapped with no gap intended, such as between reinforcement stacks 201 and 202 or between reinforcement stacks 203 and 204. It is noted that although the gaps or spaces that result from the offset laminates are shown at the tops of the stacks, those skilled in the art will appreciate that the offsetting of the laminates of the reinforcement stacks may occur at any location. For example, the offsetting may be present at the top, bottom, middle or combinations thereof. Accordingly, an offset reinforcement stack is merely one having a geometry deviating from a substantially rectangular shape.

In view of the above, one or more embodiments of the present disclosure provide an alignment feature configured to align the laminates of the reinforcement stacks in a proper geometric formation to form the reinforcement stacks. Referring to FIGS. 3-6, examples of alignment features configured to align the laminates in a reinforcement stack are shown. Although the following discussion details the features of the figures shown herein, those skilled in the art will appreciate that other geometries and/or configurations of an alignment feature that result in the formation of a reinforcement stack with a substantially rectangular shape may be used without departing from the scope of the present disclosure.

An alignment feature may be used to align the laminates when the laminates are combined and/or consolidated to form a reinforcement stack of an armor layer. The laminates may be fed from a number of spools or other elements holding the laminates, and may be fed through a consolidation mechanism that may align the individual laminates on top of each other to form the reinforcement stack. When fed through the consolidation mechanism, the laminates may be configured and aligned to form a substantially rectangular cross-section such that the laminates may be symmetrical about a center-line of the reinforcement stack that is substantially radial from the pipe axis. However, as noted, the laminates may deviate from this symmetry and/or the intended geometry. Accordingly, an alignment feature in accordance with one or more embodiments of the present disclosure may provide a means for maintaining the symmetry of the reinforcement stacks, even after being wrapped around an underlying pipe layer when forming an armor layer of the pipe.

The alignment features, as described herein, may prevent the individual laminates from sliding relative to each other after being consolidated to form the reinforcement stack. The alignment features may be geometric forms that are deviations in the shape of the laminates from a flat or rectangular cross-section. As such, the alignment features may be geometric upsets in the thickness direction of the laminates. Although described herein with a few examples, those skilled in the art will appreciate that these are merely exemplary embodiments and that the geometry, structure, and/or configuration of the alignment features are not to be limited thereby, and that other geometries, structures, and/or configurations may be employed without departing from the scope of the present disclosure.

Referring to FIG. 3, a laminate 302 in accordance with one or more embodiments of the present disclosure and a reinforcement stack 304 composed of laminates comprising a stack of laminates 302 are shown. Laminate 302 is formed in the shape of a chevron in order to provide an alignment feature. The peak 308 of the chevron may provide the alignment feature such that the peak is a point of alignment so that multiple laminates may be fitted and aligned together and stacked to form a reinforcement stack 304.

Although shown with a pronounced and visible inclination, those skilled in the art will appreciate that the inclination or angle of the chevron may be varied and may be minimized or reduced, such that alignment control is provided while reducing or minimizing a space 306 at the bottom of the reinforcement stack 304. Further, although shown with the peak 308 of the chevron pointing in an upward direction, those skilled in the art will appreciate that the inverse may be used without departing from the scope of the present disclosure. Additionally, as shown, the chevron of laminate 302 and reinforcement stack 304 may be symmetrically formed about a center line A. Alternatively, the chevron geometry may be offset from the center line A thereby forming an asymmetrically formed chevron.

The alignment feature may be formed during manufacture of the laminates. For example, the fibers of the laminates may be pultruded through a die shaped in the alignment feature cross-section configuration with a matrix material injected at the die that may be cured, or partially cured, to form the cross-section with the alignment feature. Alternatively, for example, the laminates may be extruded in the cross-section shape with the alignment feature. Those skilled in the art will appreciate that the method of forming the geometry of the laminates whether formed as a chevron or other geometry is not critical to the application of the disclosure and any known methods of manufacture may be employed without departing from the scope of the present disclosure. For example, any shape and/or configuration that may provide a deviation from a rectangular cross-section may be used without departing from the scope of the present disclosure, such as a sinusoidal and/or other wave-type deviation.

When applied to a pipe structure during manufacture, the reinforcement stack 304 may be wrapped with sufficient pressure such that the space 306 of the open end of the stack 304 may be flattened such that no space or void may be formed. Alternatively, if a space 306 or void is present, an epoxy matrix or other filler may be provided to fill the space 306. Alternatively still, an expanding filler may be applied to the lower-most laminate in the reinforcement stack 304, and may be configured to expand after application of the reinforcement stack to the pipe. For example, the expanding filler may be configured to expand during a curing process of the spoolable pipe. Alternatively still, filler, such as a tape or liquid, may be applied just before the reinforcement stack is applied to the pipe. Further, those skilled in the art will appreciate that these are merely examples of types and/or forms of fillers, and that any method or process may be used to provide filler without departing from the scope of the present disclosure.

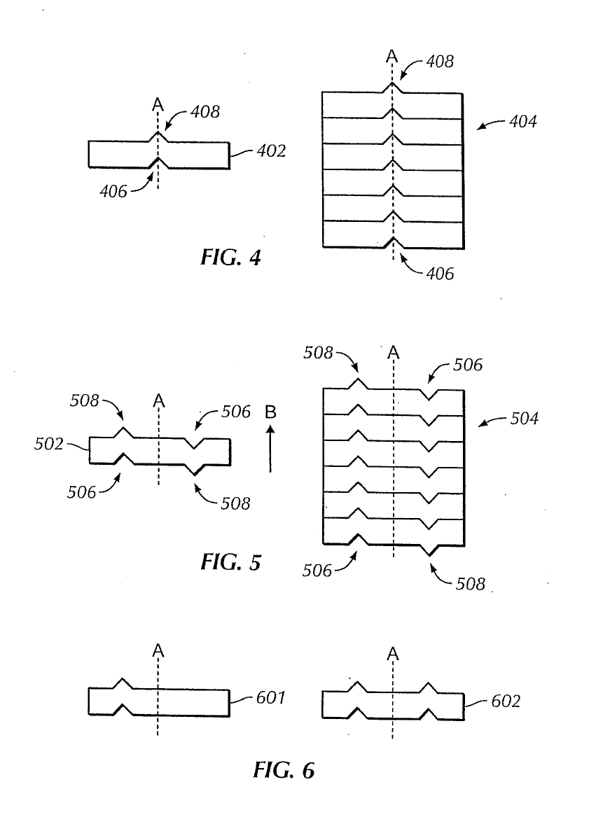

Now referring to FIG. 4, a laminate 402 and a reinforcement stack 404 in accordance with one or more embodiments of the present disclosure are shown. Laminate 402 may be formed with an alignment feature composed of a protrusion 408 and a corresponding depression 406. The alignment features 406 and 408 of laminate 402 may minimize the space of depression 406 by providing a protrusion alignment feature at a single point on laminate 402. Accordingly, laminate 402 may be substantially flat, or rectangular, except for protrusion 408 and depression 406.

As shown in FIG. 4, depressions 406 of a first laminate may correspond to the protrusion 408 of a second, and adjacently stacked, laminate. As such the depressions 406 and protrusions 408 may interlock, connect, or merely align adjacently stacked laminates in a reinforcement stack 404. As such, the depressions 406 and protrusions 408 may be aligned and interact such that voids and/or spaces between adjacently stacked laminates are minimized. Accordingly, flush alignment may be achieved, thereby maintaining a single cohesive reinforcement stack 404.

Now referring to FIG. 5, a laminate 502 and a reinforcement tape 504 in accordance with one or more embodiments of the present disclosure are shown. Laminate 502 is similar to laminate 402 in that the laminate may primarily be flat, or rectangular. However, as shown in FIG. 5, laminate 502 may be configured with two or more protrusions 508 and corresponding depressions 506. As shown, protrusions 508 may protrude from opposite sides of a laminate, in the thickness direction B of the laminate 502. Furthermore, depressions 506 may be disposed on opposite sides in the thickness direction B such that they align with protrusions 508 of adjacently stacked laminates.

As discussed above with respect to FIG. 3, the depressions 406 of laminates 402 and depressions 506 of laminates 502 may be filled with a void filling material. Alternatively, the laminates may be applied to the surface of a spoolable pipe with sufficient force to allow the depressions and protrusions to smooth out, thereby eliminating the depressions and preventing any voids or spaces from forming.

Now with reference to FIG. 6, laminates 601 and 602 are shown. Laminate 601 is shown with a single depression 606 and corresponding single protrusion 608. Laminate 602 is shown with a pair of depressions 616 and corresponding pair of protrusions 618. As shown, each of laminate 601 and laminate 602 has the protrusions and depressions asymmetrically formed about a center line A of the laminates. Although only two embodiments are shown herein with asymmetrically formed depressions and protrusions, those skilled in the art will appreciate that any asymmetrical distribution and/or geometry of depressions and protrusions may be formed without deviating from the scope of the present disclosure.

Although the embodiments discussed herein are shown with triangular geometries, this configuration is merely for example only. The alignment feature, including protrusions and depressions, may be any geometry, including, but not limited to, rectangular, square, curved, round, or wave shaped. Accordingly, those skilled in the art will appreciate that the geometry of the alignment feature is not limiting, and that any geometries may be used without departing from the scope of the present disclosure.

Advantageously, in accordance with one or more embodiments of the present disclosure, a reinforcement stack of an armor layer may be properly formed. For example, the edges of the stack may be uniformly aligned, thereby forming a rectangular stack. The rectangular configuration may allow for proper alignment between two adjacently wrapped reinforcement stacks.

Moreover, in accordance with one or more embodiments of the present disclosure, gap control may be provided by aligning the laminates of the reinforcement stacks. Intended gaps may be maintained at proper spacing because the reinforcement stacks may be formed as rectangular stacks, without significant deviations in the geometry. Because the geometry of the reinforcement stack may be controlled and maintained, offsetting of the laminates within a reinforcement stacks may be avoided, and gap width and positioning may be maintained.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

1. A reinforcement stack of a spoolable pipe, the reinforcement stack comprising:
a plurality of laminates stacked to form the reinforcement stack;
wherein at least one of the plurality of laminates comprises an alignment feature configured to align adjacently stacked laminates.

2. The reinforcement stack of claim 1, wherein the alignment feature comprises at least one protrusion and at least one depression corresponding to the at least one protrusion.

3. The reinforcement stack of claim 2, wherein the at least one protrusion and the at least one depression are distributed symmetrically about a centerline of the laminate.

4. The reinforcement stack of claim 1, wherein the alignment feature comprises a peak of a chevron geometry of each of the plurality of laminates.

5. The reinforcement stack of claim 4, wherein the chevron geometry of each laminate is formed symmetrically about a centerline of the laminate.

6. The reinforcement stack of claim 1, wherein the alignment feature is configured to align each of the plurality of laminates along a centerline of the plurality of laminates.

7. The reinforcement stack of claim 1, wherein the alignment feature comprises a geometric upset in a thickness direction of each of the plurality of laminates.

8. The reinforcement stack of claim 1, wherein the plurality of stacked laminates comprises a substantially rectangular geometry.

9. A method to manufacture a reinforcement stack of a spoolable pipe, the method comprising:
providing an alignment feature on at least one laminate of a plurality of laminates; and
arranging the plurality of laminates using the alignment feature to form the reinforcement stack.

10. The method of claim 9, wherein the alignment feature is formed by providing at least one protrusion and at least one depression corresponding to the at least one protrusion on the at least one laminate.

11. The method of claim 10, wherein a plurality of protrusions and plurality of depressions are distributed symmetrically about a centerline of the laminate.

12. The method of claim 9, wherein the alignment feature comprises a peak of a chevron geometry of each of the plurality of laminates.

13. The method of claim 12, wherein the chevron geometry of each laminate is formed symmetrically about a centerline of the laminate.

14. The method of claim 9, wherein the alignment feature allows for each of the plurality of laminates to be aligned along a centerline of the plurality of laminates.

15. The method of claim 9, the wherein the plurality of stacked laminates comprises a substantially rectangular geometry.

16.-33. (canceled)

34. A spoolable pipe comprising:
a liner;
one or more armor layers disposed external to the liner; and
an outer jacket disposed external to the one or more armor layers,
wherein at least one of the one or more armor layers comprises:
a plurality of laminates stacked to form a reinforcement stack of the armor layer,
wherein at least one of the plurality of laminates comprises an alignment feature configured to align adjacent laminates.

35. The spoolable pipe of claim 34, wherein the alignment feature comprises at least one protrusion and at least one depression corresponding to the at least one protrusion.

36. The spoolable pipe of claim 35, wherein the at least one protrusion and the at least one depression are distributed symmetrically about a centerline of the laminate.

37. (canceled)

38. (canceled)

39. The spoolable pipe of claim 34, wherein the alignment feature is configured to align each of the plurality of laminates along a centerline of the plurality of laminates.

40. The spoolable pipe of claim 34, wherein the alignment feature comprises a geometric upset in a thickness direction of each of the plurality of laminates.

41.-49. (canceled)
